(19) United States
(12) Patent Application Publication
(10) Pub. No.: US 2021/0059474 A1
(43) Pub. Date: Mar. 4, 2021

(54) FOOD PROCESSOR WITH PULSING MODE MODULE

(71) Applicants: Defond Electech Co., Ltd., Dongguan (CN); Defond Components Limited, Chai Wan (HK)

(72) Inventor: Ting Yu KWAN, Chai Wan (HK)

(73) Assignees: Defond Electech Co., Ltd., Dongguan (CN); Defond Components Limited, Chai Wan (HK)

(21) Appl. No.: 16/940,187

(22) Filed: Jul. 27, 2020

(30) Foreign Application Priority Data
Aug. 29, 2019 (CN) 201910809059.8

(51) Int. Cl. A47J 43/07; A47J 43/046; A47J 43/08

(52) U.S. Cl. CPC A47J 43/0716; A47J 43/085; A47J 43/046

(57) ABSTRACT

A food processor for use in processing food matter, the food processor including: a receptable configured for holding food matter; an electric motor; a blade configured for being rotatably driven by the electric motor so that the blade is able to blend, mix, stir, agitate or chop the food matter within the receptacle; and a pulsing mode module configured for effecting pulsed operation of the food processor with variable speed or variable torque during blending, mixing, stirring, agitating or chopping of the food matter in the receptacle.

### TECHNICAL FIELD

The present invention relates to electrical appliance such as blenders, mixers, choppers and the like.

### BACKGROUND OF THE INVENTION

Certain types of food processors allow for a pulsing mode of operation of a blade during blending, mixing, or chopping of food matter in a receptacle of the food processor. That is, rather than continuously driving rotation of the blade for an extended period, the pulsing mode enables the blade to be rotatably driven intermittently at a fixed speed as a series of short bursts of blade rotation in a pulsed manner. Pulsed operation of the food processor allows for greater control over processing of food matter in the receptacle which is desirable in certain situations to avoid food matter being processed so finely so that it becomes too liquidy instead of retaining a lumpier texture. One drawback with the pulsing mode of operation of such existing food processors is that it tends to be limited and inflexible in scope of operation meaning that it may not be suitable for processing food to a desired texture and consistency.

### SUMMARY OF THE INVENTION

The present invention seeks to alleviate at least one of the above-described problems.

The present invention may involve several broad forms. Embodiments of the present invention may include one or any combination of the different broad forms herein described.

In one broad form the present invention provides a food processor for use in processing food matter, said food processor including
a receptable configured for holding food matter;
an electric motor;
a blade configured for being rotatably driven by the electric motor so that the blade is able to blend, mix, stir, agitate or chop the food matter within the receptacle;
a pulsing mode module configured for effecting pulsed operation of the food processor during blending, mixing, stirring, agitating or chopping of the food matter in the receptacle, the pulsing mode module including:
   an input control module operable for urging by a user from an OFF state towards a plurality of different ON states in which the pulsing mode module is configured to effect pulsed operation of the food processor with the electric motor rotatably driving the blade in a plurality of different predetermined speeds or with a plurality of different predetermined torques corresponding to each of the plurality of ON states;
   a sensor module configured for sensing when the input control module is operating in the OFF state and the plurality of ON states, and for outputting a sensor signal indicative of the sensed operational state of the input control module;
   a motor controller module operably-connected with the sensor module, such that in response to the sensor signal being received from the sensor module, the motor controller module is configured to output a motor control signal indicative of the predetermined speed or torque of operation of the electric motor corresponding to the sensed operation of the input control module during pulsed operation of the food processor; and
   a motor driver module operably-connected with the motor controller module, such that in response to the motor control signal being received from the motor controller module, the motor driver module is configured to drive the electric motor at the predetermined speed or torque of operation indicated by the motor control signal; and
   wherein, the input control module of the pulsing mode module is configured to automatically return to the OFF state from any one of the plurality of ON states when the user ceases to operably urge the input control module from the OFF state towards any one of the plurality of ON states.

Preferably, the input control module may include at least one of a user-operable rotary, slidable or depressible knob or button and a touchscreen.

Preferably, the sensor module may include at least one of a variable resistor, a variable capacitor, a pressure sensor, a force sensor, a displacement sensor, a magnetic sensor, and an optical sensor.

Preferably, the motor controller module may be configured for activation in outputting motor control signals to the motor driver module only when the sensor signal received by the motor controller module is determined by the motor controller module to be greater than or equal to a predetermined threshold value.

In another broad form the present invention provides an electrical appliance for use in processing matter, said electrical appliance including:
a receptable configured for holding the matter;
an electric motor;
a blade configured for being rotatably driven by the electric motor so that the blade is able to blend, mix, stir, agitate or chop the matter within the receptacle;
a pulsing mode module configured for effecting pulsed operation of the electrical appliance during blending, mixing, stirring, agitating or chopping of the matter in the receptacle, the pulsing mode module including:
   an input control module operable for urging by a user from an OFF state towards a plurality of different ON states in which the pulsing mode module is configured to effect pulsed operation of the electrical appliance with the electric motor rotatably driving the blade in a plurality of different predetermined speeds or with a plurality of different predetermined torques corresponding to each of the plurality of ON states;
   a sensor module configured for sensing when the input control module is operating in the OFF state and the plurality of ON states, and for outputting a sensor signal indicative of the sensed operational state of the input control module;
   a motor controller module operably-connected with the sensor module, such that in response to the sensor signal being received from the sensor module, the motor controller module is configured to output a motor control signal indicative of the predetermined speed or torque of operation of the electric motor corresponding to the sensed operation of the input control module during pulsed operation of the electrical appliance; and
   a motor driver module operably-connected with the motor controller module, such that in response to the motor control signal being received from the motor controller module, the motor driver module is configured to drive the electric motor at the predetermined speed or torque of operation indicated by the motor control signal;
   wherein, the input control module of the pulsing mode module is configured to automatically return to the OFF state from any one of the plurality of ON states when the user ceases to operably urge the input control module from the OFF state towards any one of the plurality of ON states.

Preferably, the input control module may include at least one of a user-operable rotary, slidable or depressible knob or button and a touchscreen.

Preferably, the sensor module includes at least one of a variable resistor, a variable capacitor, a pressure sensor, a force sensor, a displacement sensor, a magnetic sensor, and an optical sensor.

Preferably, the motor controller module may be configured for activation in outputting motor control signals to the motor driver module only when the sensor signal received by the motor controller module is determined by the motor controller module to be greater than or equal to a predetermined threshold value.

In another broad form, the present invention provides a food processor including an electric motor configured for rotatably driving a blade to blend, mix, stir, agitate or chop food matter in a receptacle of the food processor, the food processor including a pulsing mode module configured for effecting pulsed operation of the food processor during blending, mixing, stirring, agitating or chopping of food matter in the receptacle of the food processor, the pulsing mode module including an input control module operable for urging by a user to both actuate the pulsing mode module to effect pulsed operation of the food processor and to controllably vary a speed or torque of the electric motor rotatably driving the blade during pulsed operation of the food processor.

In another broad form, the present invention provides an electrical appliance including an electric motor configured for rotatably driving a blade to blend, mix, stir, agitate or chop food matter in a receptacle of the electrical appliance, the electrical appliance including a pulsing mode module configured for effecting pulsed operation of the electrical appliance during blending, mixing, stirring, agitating or chopping of food matter in the receptacle of the electrical appliance, the pulsing mode module including an input control module operable for urging by a user to both actuate the pulsing mode module to effect pulsed operation of the electrical appliance and to controllably vary a speed or torque of the electric motor rotatably driving the blade during pulsed operation of the electrical appliance.

In another broad form, the present invention provides a pulsing mode module for use with a food processor or electrical appliance as described in accordance with any one of the preceding broad forms of the present invention.

### BRIEF DESCRIPTION OF THE DRAWINGS

The present invention will become more fully understood from the following detailed description of a preferred but non-limiting embodiments thereof, described in connection with the accompanying drawings, wherein:

FIG. 1 shows an example embodiment of a food processor having a main ON/OFF switch button, a variable speed setting control knob to vary speed during normal operation of the food processor, and a pulse mode ON/OF button to actuate pulsing mode operation of the blade at variable speeds of rotation;

FIG. 2A shows a graph of motor speed of a conventional food processor in response to distance of movement of a fixed speed pulsing mode control button during pulsing;

FIG. 2B shows a graph of motor speed of a food processor in response to variable distance of movement or variable force applied to a variable-speed pulsing mode control button from an OFF state through a range of different ON states, in accordance with an embodiment of the present invention.

FIG. 3 shows an example functional block diagram of a variable-speed pulsing mode module of a food processor in accordance with an embodiment of the present invention.

### DETAILED DESCRIPTION OF THE PREFERRED EMBODIMENTS

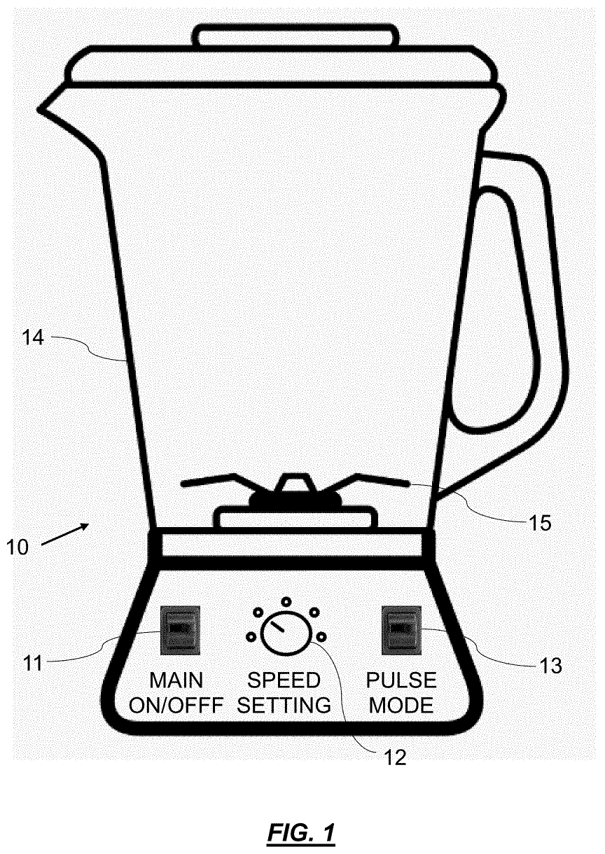

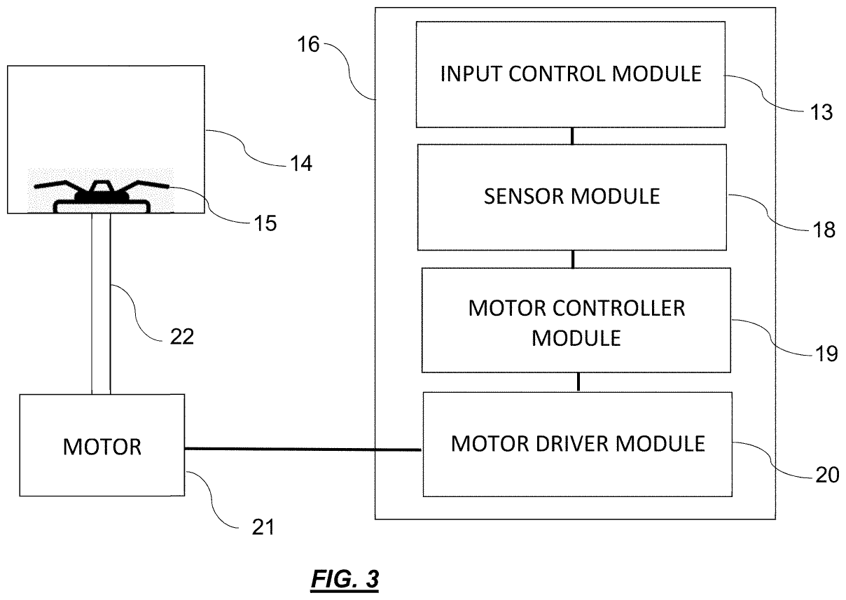

Preferred embodiments of the present invention will now be described herein with reference to FIGS. 1 to 3. The embodiments comprise a food processor (10) (e.g. a kitchen blender or chopper) having an electric motor (21) configured for rotatably driving a drive shaft (22) having a blade (15) coupled thereto so that the blade (15) may blend, mix, stir, agitate and/or chop food matter within a receptacle (14) of the food processor (10). In certain embodiments, the electric motor (21) may be configured to effect rotatable movement of the blade (15) without a drive shaft (21) or by way of some alternate drive coupling assembly between the electric motor (21) and the blade (15). For instance, the electric motor (21) may be magnetically coupled to the blade (15) so as to drive movement of the blade by magnetic force.

The food processor (10) includes a main ON/OFF switch button (11) which when actuated from the OFF position in to the ON position, is configured to electrically connect power from a power source (e.g. a battery pack) of the food processor (10) to the electric motor (21) via a first switch circuit so as to drive rotation of the blade (15). After the main ON/OFF switch button (11) has been actuated in to the ON position it remains in the ON position without the user's hand needing to continuously hold the switch button (11) in the ON position. The speed of rotation of the blade (15) when the main ON/OFF switch button (11) is ON is set by a variable speed control knob (12) which is rotatably movable by a user's hand about a plurality of different rotational positions. Responsive to movement of the variable speed control knob (12) in to the plurality of different rotational positions, a variable speed module is configured for adjusting the rotational speed of the electric motor (21) driving the blade (15) movement so as to correspond with the variable speed control knob setting (12). The blade (15) will continue to rotate at the speed set by the variable speed control knob (12) until the user manually actuates the main ON/OF switch button back (11) in to the OFF position.

A pulsing mode module (16) is also provided to enable a user to effect pulsed operation of the blade (15) rotation during blending, mixing, stirring, agitating or chopping of the food matter in the receptacle (14). That is, rather than continuously driving rotation of the blade (15) for an extended period, the pulsing mode module (16) enables the blade to be rotatably driven intermittently at variable speeds and/or with variable torques as a series of short bursts of blade rotation in a pulsed manner. Pulsing operation of the food processor (10) allows for greater control over processing of food matter in the receptacle (14) which is desirable in certain situations to avoid food matter being processed so finely so that it becomes too liquidy instead of retaining a lumpier texture. In these embodiments, the pulsing mode module (16) includes an input control module (13), a sensor module (18), a motor controller module (19), and a motor driver module (20) which are electrically connected in series.

The pulsing mode module (16) includes an input control module (13) that is operable for urging by a user from an OFF state towards a plurality of different ON states in which the pulsing mode module (16) is configured to effect pulsing mode of operation of the food processor (10) in a plurality of different predetermined speeds and/or with a plurality of different predetermined torques corresponding to each of the plurality of ON states. When actuated from the OFF state in to any one of a plurality of different ON states by the user, a second switch circuit electrically connects power from the power source to the electric motor (21) so as to drive rotation of the blade (15) at a speed corresponding to the selected ON state, during pulsing mode of operation. The speed and/or torque of rotation of the blade (15) when operating in pulsing mode will depend upon which of the ON states the input control module (13) is selectably urged in to by the user's hand. After being actuated in to any one of the ON states the input control module (13) remains in the selected ON state for as long as the user's hand continues to urge the input control module (13) in to the selected ON state.

A biasing mechanism (not shown) is configured for automatically returning the input control module (13) back towards the OFF state as soon as the user's hand ceases to urge the input control module (13) into the selected ON state. By virtue of the design and operation of the input control module (13), it provides a convenient means for controllably pulsing blade rotation at a selectably variable speed and at a selectably variable pulse duration via a single input control module (13).

The input control module (13) could for instance include any one of a user-operable rotary, slidable and/or depressible control knob, a control button or a user-interactive touchscreen display by way of example. The different possible ON states of these example input control modules could for instance be defined in terms of varying amounts of displacement (e.g. rotational displacement, depressible displacement etc), varying amounts of pressure, varying amounts of force, varying amounts of resistance, varying amounts of capacitance, or varying amounts of magnetic or optical characteristics applied to or measurable from the input device in response to operable urging of the input control module by the user from the OFF state towards the plurality of different ON states of the input control module. In certain embodiments, the input control module (13) may include a mechanism for restricting scope of movement of the input control module so that the input control module is only able to move between the OFF state and a selected ON state. For instance, an adjustable stopper element may be provided for limiting movement of the input control module beyond a certain ON state from the OFF state.

A sensor module (18) is operably-connected with the input control module (13). The sensor module (18) may include a displacement sensor for sensing a varying amount of linear or rotational displacement, a pressure sensor for sensing varying amount of pressure, a force sensor for sensing varying amounts of force, a variable resistor sensor for sensing varying amounts of resistance, a variable capacitor sensor for sensing varying amounts of capacitance, a magnetic sensor for sensing magnetic flux, and an optical sensor configured for sensing variations in optical characteristics resulting from operation of the input control module (13) as it is operably arranged between the OFF state and any one of the plurality of different ON states. The sensor module (18) is configured to communicate a sensor signal to a motor controller module (19) that is indicative of the sensed variation in displacement, pressure, force, resistance, capacitance, magnetic field and/or optical characteristics resulting from operation of the input control module (13). The sensor signal may for instance comprise an electrical/electronic signal generated by suitable electrical/electronic circuitry. It would be appreciated that in alternate embodiments the sensor module signal could comprise an optical or mechanical signal generated by suitable optical or mechanical signalling elements. In one example embodiment, the input control module (13) could include a rotary control knob and the sensor module (18) could comprise a variable resistor operably-connected with the control knob such that the resistance changes in response to rotational movement of the control knob. In another example embodiment, the input control module (13) could comprise a depressible button that is operably-connected with a sensor module (18) comprising a variable capacitor such that the capacitance changes in response to depressible displacement of the control button by the user. It would be appreciated by a person skilled in the art that the other types of sensors examples may be similarly employed in analogous manner. Furthermore, in these embodiments, when the input control module (13) is released by the user's hand and the biasing mechanism urges the input control module back in to the default OFF state, the sensor module is configured to switch OFF.

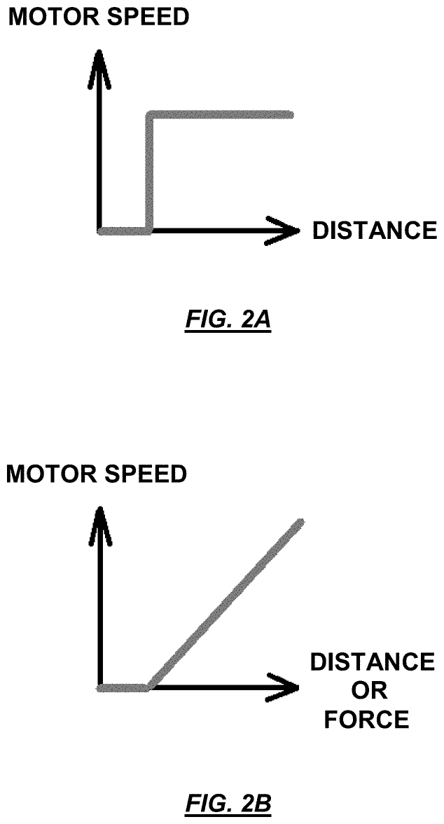

A motor controller module (19) includes a processor module and associated memory module disposed on a printed circuit board and is operably-connected with the sensor module (18) whereby it receives the sensor signal from the sensor module (18). In response to receiving the sensor signal, the motor controller module (19) is configured o output a motor control signal that is indicative of a predetermined speed and/or torque operation of the electric motor (21) that corresponds to the sensor signal to be effected during pulsing mode of operation of the electrical appliance (10). The predetermined speed and/or torque of the electric motor (21) that is indicated by the output motor control signal may be determined by reference to a lookup table stored in the memory module whereby the lookup table contains predetermined correspondence between predetermined speeds and/or torques and the values indicated by the received sensor signals. In these embodiments, the motor controller module (19) is also configured to output the motor control module signal only when the sensor signal value is determined to meet a predetermined criteria. For instance, the sensor signal value may be required to be equal to or greater than a predetermined threshold signal value such as a predetermined distance of movement or predetermined amount of pressure applied to the input control module, or a resistance or capacitance value resulting from operation of the input control module (13), by way of example. By configuring the motor controller module (19) in this manner with a required startup threshold for activation, this may assist in alleviating potential mis-operation of the pulsing mode module (16) and may also assist in reducing unnecessary power consumption. FIG. 2B shows for instance a graph of variable motor speed of the electric motor (21) in response to variations in travel/force applied to the input control module. It can be seen that output power only begins to ramp up after a predetermined threshold sensor signal value indicative of a threshold amount of variation in distance or force applied to the input control module (13) is sensed.

A motor driver module (20) comprises suitable electrical/electronic circuitry operably-connected with the output of the motor controller module (19) and is also operably-connected with input terminals of the electric motor (21). The motor driver module (20) circuitry includes suitable semiconductor power devices such as varistors, MOSFETS and the like that are disposed on the same printed circuit board as the motor controller module (19), however, in alternate embodiments they may be disposed on separate printed circuit boards. The motor driver module (20) is configured to receive the motor controller signal from the motor controller module (19) and whereby in response to the received motor controller signal, it is configured to output suitable signals to variably drive the rotational speed and/or torque of electric motor (21) during pulsing mode of operation. By way of example, the output motor controller signal from the motor controller module (19) may be fed to the input of a gate driver circuit which is configured for driving operation of the semiconductor power devices to variably drive the rotational speed and/or torque of the electric motor (21). Variations in speed and/or torque of the electric motor may for instance be controlled by way of a pulse widthw modulation module for effecting pulse width modulation or any other switched mode of operation to controllably limit the power delivered to input terminals of the electric motor (21) via the semiconductor power devices.

It will be appreciated from the above described embodiments that a pulsing mode module (16) is now provided which allows for variable speed and/or torque of the electric motor rotatably driving the blade during pulsing mode of the food processor (10). Hence, in these embodiments, the pulsing mode module (16) provides an improvement over existing food processors in which the rotational speed of the blade (15) during pulsing is restricted to a fixed speed. Furthermore, speed and/or torque of rotation of the blade (15) and the duration of the rotation of the blade (15) during pulsing of the food processor (10) may be conveniently controlled by the user via a single input control module (13) in a single step. This also results in improved space utilisation on the user control panel of the food processor (10) since only a single input control module device (i.e. a single control button or control knob) may be required to controllably adjust the speed and/or torque of rotation of the blade (15) and duration of rotation of the blade (15) during pulsing of the food processor (10). However, it is possible that in alternate embodiments, the variable speed and/or variable torque setting to be effected during pulsing mode operation could be set via a separate control knob or the like.

Yet further, the speed and/or torque of rotation of the blade (15) during pulsing mode may be variably adjusted in a smooth and continuous manner by operable urging of the input control module (13) from the OFF state progressively through each of the plurality of different ON states of the input control module. FIG. 2A depicts a graph of motor speed in response to operation of the input control module (13), for instance in terms of the distance the input control module is rotated for a conventional fixed speed pulsing mode module of a food processor. It can be seen that because the conventional pulsing mode module is operational in only one OFF state and one ON state, there is a discrete jump in speed of the motor speed and blade rotation when the pulsing mode module is operated by the user which is undesirable in certain situations. In contrast, and as shown in the graph of FIG. 2B, with the variable-speed embodiments of the pulsing mode module (16), after the threshold distance, force (or other measurable parameter of operation of the input control module) is determined by the motor controller module (19) from the received sensor signals, the motor controller module (19) then outputs motor controller signals which results in gradual and continuous increase in motor speed as the input control module (13) is operably urged from the OFF state progressively through the plurality of different ON states of the pulsing mode input control module.

Yet further, it would be appreciated from the above described embodiments and examples that such may be advantageous over conventional technologies in that the design and implementation of such embodiments may be relatively cost-effective as components such has the sensor module are relatively inexpensive. Furthermore, the additional integration of additional components such as the sensor module and the like occupy relatively little additional space and therefore may be readily accommodated within the housing of a typical food processor housing.

It would be appreciated and understood that whilst the embodiments are described in relation to kitchen appliances for processing food matter, this is merely for illustrating an example application of the inventive concept. Alternate embodiments of the present invention may be suitably adapted for use with other types of electric devices such as industrial processing machinery for instance to mix chemicals and other matter that is not for human consumption. Furthermore, whilst embodiments of the present invention described herein refer to electric devices comprising an electric motor, it would be appreciated that alternate embodiments of the present invention may also be applicable to electric devices which comprise a solenoid type electro-mechanical unit to effect operable movement (e.g. reciprocal motion) of the electric device.

Any one of the features of the embodiments described herein referred to as a “module” may be implemented in software for execution by various types of processors. An identified module of executable code may, for instance, comprise one or more physical or logical blocks of computer instructions which may, for instance, be organised as an object, procedure, function, or algorithm. The identified blocks of computer instructions need not be physically located together, but may comprise disparate instructions stored in different locations which, when joined logically together, comprise the module and achieve the stated purpose for the module. A module may also be implemented as a hardware circuit comprising custom circuits or gate arrays, off-the-shelf semiconductors such as logic chips, transistors, or other discrete components. A module may also be implemented in programmable hardware devices such as field programmable gate arrays, programmable array logic, programmable logic devices or the like. A module of executable code may comprise a single instruction, multiple instructions, and may be distributed over several different code segments, among different programs, and across several discrete memory devices. Similarly, operational data may be identified and illustrated herein within modules, and may be embodied in any suitable form and organised within any suitable type of data structure. The operational data may be collected as a single data set, or may be distributed over different locations including over different storage devices, and may exist, at least partially, merely as electronic signals on a system or network.

It is noted that, when a component is described to be “fixed”, “coupled”, “attached”, “engaged”, “connected” or the like to another component, it may be directly fixed to the another component or there may be an intermediate component unless expressly or implicitly stated to the contrary. When a component is described to be “disposed” on or in another component, it can be directly disposed on or in the another component or there may be an intermediate component unless expressly or implicitly stated to the contrary.

Unless otherwise specified, all technical and scientific terms have the ordinary meaning as commonly understood by persons skilled in the art. The terms used in this disclosure are illustrative rather than limiting. The term “and/or” used in this disclosure means that each and every combination of one or more associated items listed are included.

Those skilled in the art will appreciate that the invention described herein is susceptible to variations and modifications other than those specifically described without departing from the scope of the invention. All such variations and modification which become apparent to persons skilled in the art, should be considered to fall within the spirit and scope of the invention as broadly hereinbefore described. It is to be understood that the invention includes all such variations and modifications. The invention also includes all of the steps and features, referred or indicated in the specification, individually or collectively, and any and all combinations of any two or more of said steps or features.

The reference to any prior art in this specification is not, and should not be taken as, an acknowledgment or any form of suggestion that that prior art forms part of the common general knowledge.

1. A food processor for use in processing food matter, the food processor including:
a receptacle configured for holding food matter;
an electric motor;
a blade configured for being rotatably driven by the electric motor so that the blade is able to blend, mix, stir, agitate or chop the food matter within the receptacle;
a pulsing mode module configured for effecting pulsed operation of the food processor during blending, mixing, stirring, agitating or chopping of the food matter in the receptacle, the pulsing mode module including:
an input control module operable for urging by a user from an OFF state towards a plurality of different ON states in which the pulsing mode module is configured to effect pulsed operation of the food processor with the electric motor rotatably driving the blade in a plurality of different predetermined speeds or with a plurality of different predetermined torques corresponding to each of the plurality of ON states;
a sensor module configured for sensing when the input control module is operating in the OFF state and the plurality of ON states, and for outputting a sensor signal indicative of the sensed operational state of the input control module;
a motor controller module operably-connected with the sensor module, such that in response to the sensor signal being received from the sensor module, the motor controller module is configured to output a motor control signal indicative of the predetermined speed or torque of operation of the electric motor corresponding to the sensed operation of the input control module during pulsed operation of the food processor; and
a motor driver module operably-connected with the motor controller module, such that in response to the motor control signal being received from the motor controller module, the motor driver module is configured to drive the electric motor at the predetermined speed or torque of operation indicated by the motor control signal; and
wherein, the input control module of the pulsing mode module is configured to automatically return to the OFF state from any one of the plurality of ON states when the user ceases to operably urge the input control module from the OFF state towards any one of the plurality of ON states.

2. The food processor of claim 1, wherein the input control module includes a user-operable rotary, slidable or depressible knob or button and a touchscreen.

3. The food processor of claim 1, wherein the sensor module includes at least one of a variable resistor, a variable capacitor, a pressure sensor, a force sensor, a displacement sensor, a magnetic sensor, and an optical sensor.

4. The food processor of claim 1, wherein the motor controller module is configured for activation in outputting motor control signals to the motor driver module only when the sensor signal received by the motor controller module is determined by the motor controller module to be greater than or equal to a predetermined threshold value.

5. An electrical appliance for use in processing matter, said electrical appliance including:
a receptacle configured for holding the smatter;
an electric motor;
a blade configured for being rotatably driven by the electric motor so that the blade is able to blend, mix, stir, agitate or chop the matter within the receptacle;
a pulsing mode module configured for effecting pulsed operation of the electrical appliance during blending, mixing, stirring, agitating or chopping of the matter in the receptacle, the pulsing mode module including:
an input control module operable for urging by a user from an OFF state towards a plurality of different ON states in which the pulsing mode module is configured to effect pulsed operation of the electrical appliance with the electric motor rotatably driving the blade in a plurality of different predetermined speeds or with a plurality of different predetermined torques corresponding to each of the plurality of ON states;
a sensor module configured for sensing when the input control module is operating in the OFF state and the plurality of ON states, and for outputting a sensor signal indicative of the sensed operational state of the input control module; a motor controller module operably-connected with the sensor module, such that in response to the sensor signal being received from the sensor module, the motor controller module is configured to output a motor control signal indicative of the predetermined speed or torque of operation of the electric motor corresponding to the sensed operation of the input control module during pulsed operation of the electrical appliance; and
a motor driver module operably-connected with the motor controller module, such that in response to the motor control signal being received from the motor controller module, the motor driver module is configured to drive the electric motor at the predetermined speed or torque of operation indicated by the motor control signal;
wherein, the input control module of the pulsing mode module is configured to automatically return to the OFF state from any one of the plurality of ON states when the user ceases to operably urge the input control module from the OFF state towards any one of the plurality of ON states.

6. The electrical appliance of claim 5, wherein the input control module includes a user-operable rotary, slidable or depressible knob or button and a touchscreen.

7. The electrical appliance of claim 5, wherein the sensor module includes at least one of a variable resistor, a variable capacitor, a pressure sensor, a force sensor, a displacement sensor, a magnetic sensor, and an optical sensor.

8. The electrical appliance of claim 5, wherein the motor controller module is configured for activation in outputting motor control signals to the motor driver module only when the sensor signal received by the motor controller module is determined by the motor controller module to be greater than or equal to a predetermined threshold value.

9. A food processor including an electric motor configured for rotatably driving a blade to blend, mix, stir, agitate or chop food matter in a receptacle of the food processor, the food processor including a pulsing mode module configured for effecting pulsed operation of the food processor during blending, mixing, stirring, agitating or chopping of food matter in the receptacle of the food processor, the pulsing mode module including an input control module operable for urging by a user to both actuate the pulsing mode module to effect pulsed operation of the food processor and to controllably vary a speed or torque of the electric motor rotatably driving the blade during pulsed operation of the food processor.

10. An electrical appliance including an electric motor configured for rotatably driving a blade to blend, mix, stir, agitate or chop food matter in a receptacle of the electrical appliance, the electrical appliance including a pulsing mode module configured for effecting pulsed operation of the electrical appliance during blending, mixing, stirring, agitating or chopping of food matter in the receptacle of the electrical appliance, the pulsing mode module including an input control module operable for urging by a user to both actuate the pulsing mode module to effect pulsed operation of the electrical appliance and to controllably vary a speed or torque of the electric motor rotatably driving the blade during pulsed operation of the electrical appliance.

11. A pulsing mode module for use with a device chosen from the group consisting of a food processor and an electrical appliance.
